(19) United States
(12) Patent Application Publication
(10) Pub. No.: US 2022/0275728 A1
(43) Pub. Date: Sep. 1, 2022

(54) THREE-DIMENSIONAL CERAMIC MATRIX COMPOSITE T-JOINT FOR AIRFOILS VIA PIN-WEAVING

(71) Applicant: Siemens Energy Global GmbH & Co. KG, München (DE)

(72) Inventor: Jay A. Morrison, Mims, FL (US)

(21) Appl. No.: 17/634,574

(22) PCT Filed: Aug. 22, 2019
(86) PCT No.: PCT/US2019/047655

§ 371 Date: Feb. 11, 2022

(51) Int. Cl. F01D 5/28; F01D 5/14

(52) U.S. Cl. CPC F01D 5/282; F01D 5/147; F01D 5/284; F05D 2300/6033; F05D 2300/6034

(57) ABSTRACT

A component formed of a three-dimensional ceramic matrix composite material (CMC) is provided. The component includes a first wall and a second wall that intersects the first wall at an angle such that the intersection forms a T-joint. The component also includes a continuous tensioning fiber attached between the first wall and the second wall having a portion spanning the T-join so that the tensioning fiber remains in tension under internal pressure loading to provide strength while reducing stress at the T-joint. The tensioning fiber, the first wall, and the second wall together form the component in the CMC material.

### BACKGROUND

### 1. Field

Aspects of the disclosure generally relate to three dimensional (3D) ceramic matrix composite (CMC) components formed by pin weaving techniques, and more particularly, to a component having an improved T-Joint, or an airfoil having an improved T-joint, via pin-weaving.

### 2. Description of the Related Art

Gas turbines comprise a casing or cylinder for housing a compressor section, a combustion section, and a turbine section. High efficiency of a gas turbine is achieved by heating the gas flowing through the combustion section to as high a temperature as is practical. However, the hot gas may degrade various metal turbine components, such as the combustor, transition ducts, vanes, ring segments, and turbine blades as it flows through the turbine.

High temperature resistant ceramic matrix composite (CMC) materials have been developed and are increasingly utilized in gas turbine engines. Typically, CMC materials include a ceramic matrix material, which is reinforced with a plurality of reinforcing ceramic fibers or ceramic particles. The fibers may have predetermined orientations(s) to provide the CMC materials with additional mechanical strength. In addition, the composites may be in the form of a laminate formed of a plurality of laminar layers. However, the interlaminar strength of composites comprising laminar layers has been weak. As CMC materials perform better at higher temperatures than metallic alloys, they are potentially very valuable for implementation into gas turbines.

While CMC materials provide excellent thermal protection properties relative to superalloy materials, their mechanical strength is still notably less than that of corresponding high temperature superalloy materials. In particular, laminated (2D) CMC materials have low interlaminar strength, and thus are prone to delamination or other structural damage during high temperature operation. Delamination occurs when the laminates separate and come apart under stress. In addition, due to their low thermal conductivity and heat transfer coefficient, CMC materials are difficult to cool. By way of example, FIG. 1 illustrates an airfoil 10 formed from a CMC material having an outer wall 12 defining a large cavity 14 through which a cooling air may flow. During high temperature operation, the flow of cooling air through the cavity 14 results in a high-pressure differential (P1-P2) between the interior of the cavity 14 and an outside of the airfoil 10. Unfortunately, the high internal pressure will likely result in damage to the CMC outer wall 12 or outright splitting of the airfoil 10 at the trailing edge 16. In addition, the flow of air through cavity 14 will have little effect on cooling the CMC material closest to an exterior 18 of the airfoil 10 since CMC materials have a low thermal conductivity. In certain embodiments, the CMC material may be formed of a plurality of plies 20. Additionally, the trailing edge 16 may include a trailing edge filler 21 for eliminating voids in the trailing edge portion.

Further, introducing internal wall cooling channels in two dimensional (2D) laminated CMC components to cool the component has been demonstrated (see U.S. Pat. No. 6,746,755 and U.S. Pat. No. 8,257,809). However, even with some cooling effect, such components have limited internal pressure containment capability due to the low interlaminar strength of 2D CMCs. For large land-based turbine front stage airfoils, each front stage airfoil should be able to withstand an airfoil internal pressurization and/or pressurization of internal wall cooling channels as high as 10 bar or more. Thus, there is a need for CMC structures with greater robustness for such internal pressurization.

To mitigate the internal pressure, airfoils 10 have further been manufactured with one or more internal ribs 22 which span between the pressure side 24 and the suction side 26 of the airfoil 10 as shown in FIG. 2. While the ribs 22 assist in reducing the stresses associated with the high internal pressure, particularly at the leading edge 28 and the trailing edge 16, the T joints 30 (where the ribs 22 meet an outer wall 12) cannot withstand the high pressures and are prone to failure. Conventional 2D CMC layup ribs, i.e., the rib 22 comprises a 2D CMC material having fibers spanning in one plane, require a T-joint 30 at the rib-to skin interface which is prone to delamination under these pressures. For example, FIG. 3 illustrates an enlarged view of the T-joint 30 of the airfoil 10 shown in FIG. 2 at the rib to skin (skin of the outer wall 12) interface after a specific time under normal turbine operation. In this example, interlaminar failure is shown between the inner and outer plies 20 of the CMC material starting at the T-joint 30. Consequently, an airfoil with a more robust T-joint configuration is desired.

### SUMMARY

Briefly described, aspects of the present disclosure relate to a component formed of a 3D ceramic matrix composite material, an airfoil formed of a 3D ceramic matrix composite material, and a method of forming a 3D ceramic matrix composite material component having a T-joint.

In one aspect, there is disclosed an airfoil formed of a 3D CMC material. The airfoil includes an outer wall, the outer wall including a pressure side and a suction side. The outer wall defines a cavity through which a flow of cooling air flows. Extending between the pressure side and the suction side and through the cavity is a rib. At an intersection of the rib and the outer wall, a T-joint is formed. The airfoil also includes a continuous tensioning fiber. The continuous tensioning fiber is attached between the outer wall and the rib and has a portion that spans the T-joint so that the tensioning fiber remains in tension under internal pressure loading to reinforce the T-joint. The tensioning fiber, the outer wall, and the rib together form the airfoil in the CMC material.

A second aspect provides a component formed of a 3D CMC material. The component includes a first wall and a second wall, the second wall intersecting the first wall at an angle such that the intersection forms a T-joint. The component also includes a continuous tensioning fiber attached between the first wall and the second wall having a portion spanning the T-joint so that the tensioning fiber remains in tension under internal pressure loading to provide strength while reducing stress at the T-joint. The tensioning fiber, the outer wall, and the rib together form the component in the CMC material.

A third aspect provides a method of forming a 3D CMC component having a T-joint utilizing a pin weaving technique. The method includes positioning a plurality of spanwise extending reinforcement members to define an outer wall of the component. The method also includes positioning a plurality of spanwise extending reinforcement members to define a rib, the rib intersecting the outer wall at an angle such that the intersection forms a T-joint. A wall fiber is then woven about the outer wall reinforcement members for forming the outer wall. Additionally, the wall fiber is woven about rib reinforcement members for forming the rib. Further, the method includes weaving a continuous tensioning fiber between the outer wall reinforcement members alternately with the wall fiber. The continuous tensioning fiber is then woven between the rib reinforcement members alternately with the wall fiber. At the T-joint, a portion of the tensioning fiber spans the T-joint so that the tensioning fiber remains in tension under internal pressure loading to reinforce the T-joint. The tensioning fiber, the outer wall, and the rib together form the component in the CMC material.

### BRIEF DESCRIPTION OF THE DRAWINGS

FIG. 1 illustrates an embodiment of a prior art airfoil.

FIG. 2 illustrates a further embodiment of a prior art airfoil.

FIG. 3 illustrates an embodiment of a T-joint of the prior art airfoil of FIG. 2 experiencing interlaminar failure between inner and outer plies of the CMC material.

FIG. 4 illustrates a schematic of a gas turbine engine which incorporates a component in accordance with an aspect of the present invention.

FIG. 5 illustrates a reinforced woven CMC component in accordance with an aspect of the present invention.

FIG. 6 illustrates a cross sectional view of an airfoil component including 3D woven material and defining ribs intersecting the outer wall at T-joints.

FIG. 7 illustrates a cross sectional view of an embodiment of a T-joint having CMC material utilizing a pin weaving technique with a tensioning fiber.

FIG. 8 illustrates a zoomed in view of an embodiment of the T-joint of FIG. 6 having CMC material utilizing a pin weaving technique with a tensioning fiber.

FIG. 9 illustrates a zoomed in view of a further embodiment of the T-joint of FIG. 6 having CMC material utilizing a pin weaving technique with a tensioning fiber.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

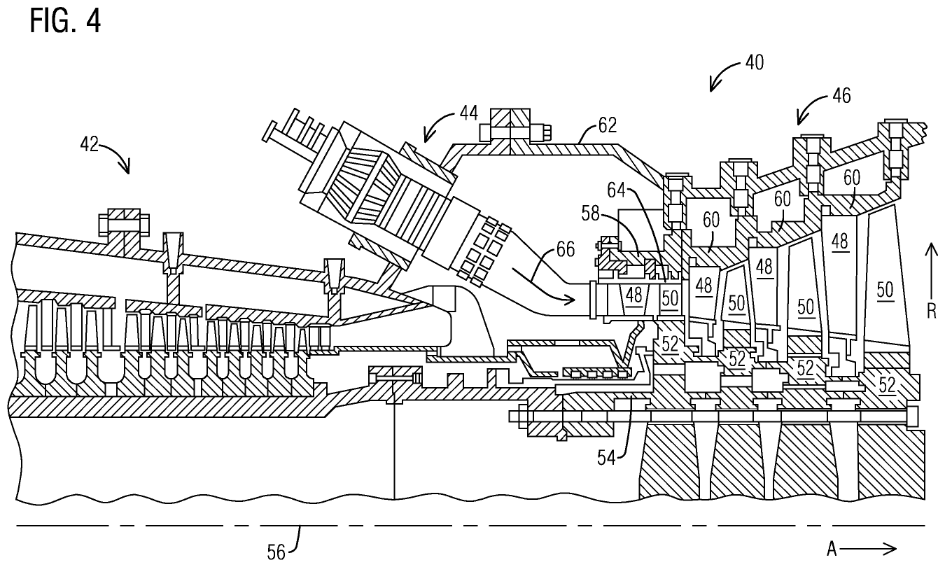

Referring again to the Figures, FIG. 4 illustrates a gas turbine engine that includes one or more components formed from a ceramic matrix composite (CMC) material as described herein. The gas turbine engine 40 includes a compressor section 42, a combustor section 44, and a turbine section 46. The turbine section 46 includes alternating rows of stationary airfoils 48 (i.e. “vanes”) and rotating airfoils 50 (i.e. “blades”). Each row of blades 50 is formed by a circular array of airfoils connected to an attachment disc 52 disposed on a rotor 54 having a rotor axis 56. The airfoils 48, 50 extend substantially spanwise along a radial direction R of the axis 56 of the gas turbine engine 40. The blades 50 extend radially outward R from the rotor 54 and terminate in blade tips. The vanes 48 extend radially inward from an inner surface of vane carriers 58, 60 that are attached to an outer casing 62 of the gas turbine engine 40. A ring seal 64 is attached to an inner surface of the vane carrier 58 and between rows of vanes 48. The ring seal 64 is a stationary component that acts as a hot gas path guide between the rows of vanes 48 at the locations of the rotating blades 50. The ring seal 64 is commonly formed by a plurality of ring segments that are attached either directly to the vane carriers 58, 60 or indirectly such as by attachment to metal isolation rings attached to the vane carriers 58, 60. During engine operation, high temperature/high velocity gases 66 flow primarily axially A with respect to the rotor axis 56 through the rows of vanes 48 and blades 50 in the turbine section 46.

A component comprising a 3D CMC material, such as that used in a gas turbine engine, may be formed using a pin weaving technique. In order to improve upon the weak interlaminar strength of laminated (2D) CMC materials, a pin weaving technique has been developed in which reinforcing materials such as fibers or pins are introduced in the third dimension hosted within a matrix material such that they extend between the laminate layers. 3D fiber-reinforced T-joints have been utilized previously, however, most designs do not provide a stiffening capability at the T-joint. Additionally, while the interlaminar strength of the CMC has been increased utilizing 3D pin weaving techniques, there has been no reduction in stress at the T-joint.

Broadly, a component formed of a three-dimensional (3D) ceramic matrix composite (CMC) material including an improved T-joint is proposed. The component includes a first wall and a second wall intersecting the first wall such that a T-joint is formed. The 3D CMC material includes a continuous tensioning fiber that spans the T-joint so that the tensioning fiber remains in tension during internal pressurization of the airfoil cavity to reinforce the T-joint. For the purposes of this disclosure, the component will be referred to throughout the disclosure as an airfoil of a gas turbine engine. However, one skilled in the art will understand that the component may be any component formed of a CMC structure having a T-joint.

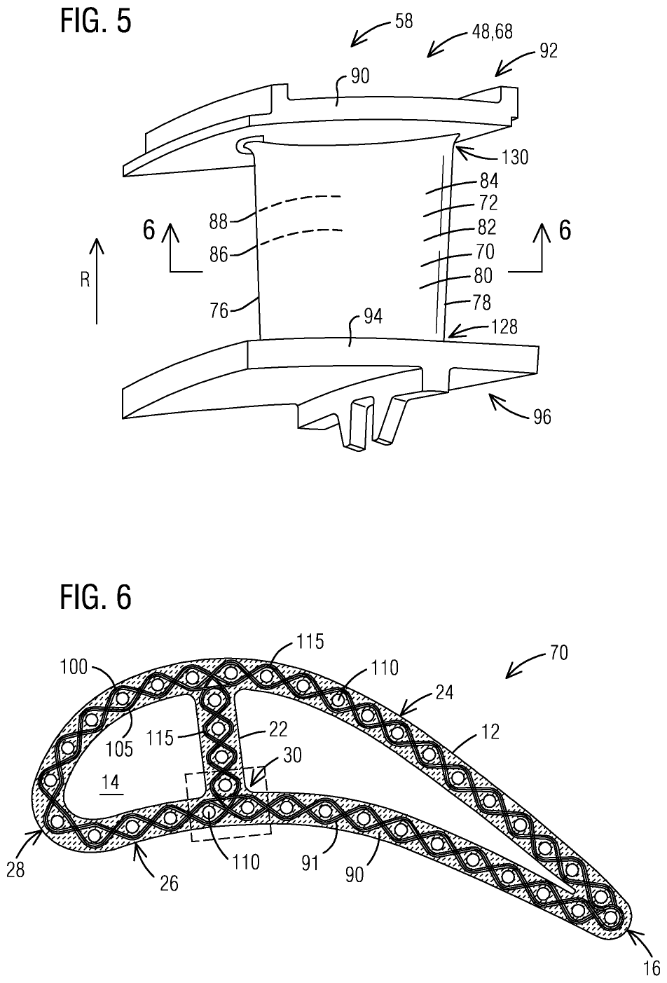

Referring to FIG. 5, a reinforced component 68 is shown in accordance with an aspect of the current invention which may comprise a gas turbine vane 48 described in connection with FIG. 4. In the embodiment of FIG. 4, the component 68 comprises a vane 48. The vane 48 includes an elongated airfoil portion 70 having a body 72 that extends in a substantially spanwise or radial direction R. The body 72 is defined between a leading edge 76 and a trailing edge 78, and further includes an outer wall 80. The outer wall 80 may have a substantially concave-shaped portion 82 defining a pressure side 84 and a substantially convex shaped portion 86 on an opposite side defining a suction side 88. The airfoil portion 70 is disposed between an outer platform 90 at a first end 92 of the vane 48 and an inner platform 94 at a second end 96 of the vane 48. Although a vane 48 is shown, it is appreciated that the component 68 is not limited to a vane 48, but may include any component for high temperature use, such as another component of a gas turbine engine 40 shown in FIG. 4, e.g., a turbine blade 50 having an airfoil portion.

Referring to FIG. 6, a cross sectional view along view line 6-6 of FIG. 5 of airfoil component 70 is shown. In an embodiment, the airfoil 70 is formed from a 3D CMC material utilizing a conventional pin weaving technique. The airfoil 70 includes an outer wall 12 comprising a pressure side 24 and a suction side 26, the pressure side 24 separated from the suction side 26 to form a cavity 14 through which a flow of cooling air flows. A rib 22 may extend from the pressure side 24 to the suction side 26 forming a T-joint 30 at the intersection of the rib 22 with the outer wall 12.

The airfoil 70 also includes wall fibers 115, materials that are woven around reinforcement members 110. In certain embodiments, the wall fibers 115 are each continuous fiber bundles extending in an axial direction A from the leading edge 28 to the trailing edge 16 and woven about the reinforcement members 110, respectively, on a layer by layer basis to build the airfoil 70. In an embodiment, the wall fibers 115 also extend throughout the rib 22 from the pressure side 24 to the suction side 26 while being woven about the reinforcement members 110.

As shown, reinforcement members 110 may extend in a spanwise radial R direction from the root of the airfoil 70 to a tip of the airfoil 70. The reinforcement members 110 may be oriented about a perimeter of the airfoil 70 such that when fiber material 115 is woven around the reinforcement members 110 on a layer by layer basis, the airfoil 70 is formed with an airfoil shape. Additionally, the reinforcement members 110 may be oriented to extend spanwise R within the rib 22. In one aspect of 3D pin weaving, the wall fiber material 115 may be woven about the reinforcement members 110 such that at least a portion of the wall fiber material travels over selected reinforcement members 110 in a first pass and under the same selected reinforcement members in a second pass. This may be done repeatedly so as to build the body 72 of the airfoil 70. In a particular embodiment, as seen in FIG. 6, the fiber material 115 travels over each reinforcement member 110 in a first pass 100 and then back under the same reinforcement member in a second pass 105. This pattern may also continue into the rib 22. In this example, the wall fibers 115 at the T-joint 30 do not cross the joint at an angle that gives any bending stiffness and thus does not reduce the stress at the joint 30.

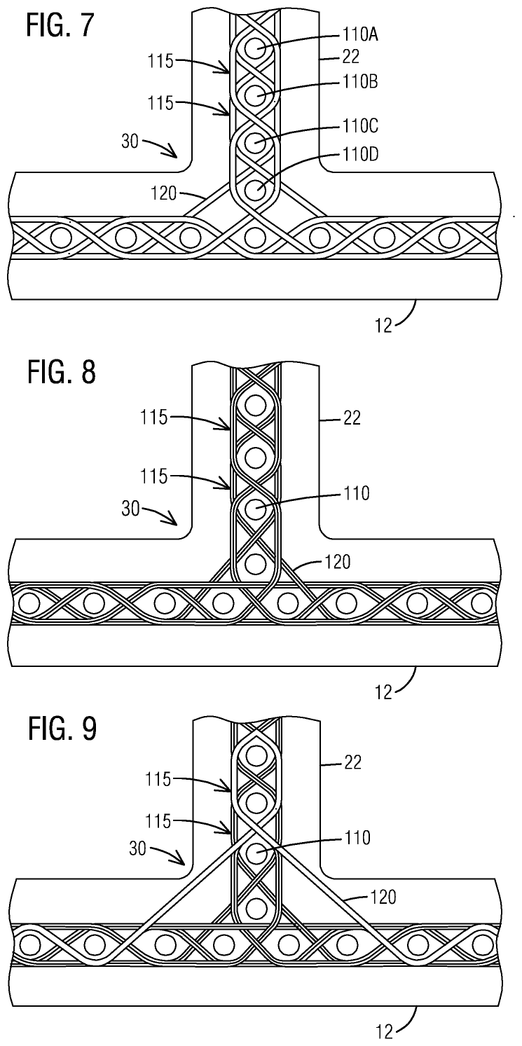

In order to remedy this issue and increase the bending stiffness at the joint, the present inventor proposes a 3D pin weaving technique utilizing continuous tensioning fibers at the T-joint. The tensioning fiber is formed as a single piece or unit that forms a continuous fiber with no relative weak points. In an embodiment shown in FIG. 7 of a zoomed-in view of the airfoil T-joint 30, the airfoil 70 may include wall fibers configured as a continuous tensioning fiber 120 woven between the reinforcement members 110 and attached between the outer wall 12 and the rib 22. The tensioning fiber 120 includes a portion that spans the T-joint 30 such that the tensioning fiber 120 remains in tension to reinforce the T-joint 30. In a similar manner to a basic civil engineering principle in which structural tension members are utilized to carry a load in its ideal, i.e., strongest, direction by remaining in tension, the tensioning fiber 120 is utilized to ‘bridge’ the corner of the T-joint 30 and reinforce the T-joint 30. In this way, the tensioning fiber 120 crosses the joint at an angle to provide a bending stiffness to the T-joint 30 in much the same way as the cables in a cable-stayed bridge support the weight of the bridge deck.

In the shown embodiment of FIG. 8, fiber material 115 is woven such that it travels over a pair of selected reinforcement members 110 in the first pass and under the same pair selected reinforcement members 110 in a second pass. This pattern may be repeated over and over to build the body 72 of the airfoil 70 in the spanwise R direction. In an embodiment, the continuous tensioning fiber 120 is woven such that it also travels over a second pair of selected reinforcement members 110 in the first pass and under the same selected second pair of reinforcement members 110 in a second pass. For example, referring to FIG. 7, within the rib 22, wall fiber 115 travels over and under reinforcement members 110A and 110B in a first and second pass, respectively and travels over and under reinforcement fibers 110B and 110C in a first and second pass. While for exemplary purposes, the wall fibers 115 weave about a pair of reinforcement members 110, the wall fibers 115 may weave about between 1-4 reinforcement members in different embodiments.

At the T joint 30, the tensioning fiber 120 extends to the outer wall 12 such that the portion of the tensioning fiber spanning the T-joint 120 forms an angle with the outer wall 12. In an embodiment, the angle is approximately 45 degrees with the outer wall 12 such that the tensioning fiber 120 forms a triangular shape at the T-joint 30. Within the outer wall 12, the tensioning fiber 120 continues the pattern of traveling over a pair of selected reinforcement members 110 in a first pass and under the same pair of selected reinforcement members 110 in a second pass.

Further 3D pin weaving embodiments with the continuous tensioning fiber 120 are possible as well. For example, FIG. 8 illustrates a similar example as FIG. 7 but with a variation in the pattern within the T-joint 30 where only a portion of the wall fibers 115 transition to the rib 22 as tensioning members 120. Such an embodiment has higher fiber density within the T-joint region and is able to withstand a variety of loadings besides just internal pressure (i.e., bending and thermal loads). In the embodiment of FIG. 9, the angle the tensioning fiber 120 has with the outer wall 12 is slightly greater than 45 degrees as the tensioning fiber 120 bridges the joint from a more interior location on the rib 22 with the cavity 14 of the airfoil 70. While several embodiments have been illustrated as examples, other embodiments may also exist such that the tensioning fiber 120 remains in tension to reinforce the joint.

The ceramic matrix composite (CMC) material comprises a fiber material 91 hosted with a ceramic matrix material 90 as illustrated in FIG. 6. The CMC material may be an Oxide-Oxide CMC material comprising an oxide-oxide matrix material having oxide fibers 91 disposed within an oxide matrix 90. The Oxide-Oxide CMC material gives the component a capability to perform in an environment up to approximately 1200° C. Alternately, the CMC material may be a silicon carbidesilicon carbide CMC material. The fibers of the fiber material 91 may be continuous or long discontinuous fibers.

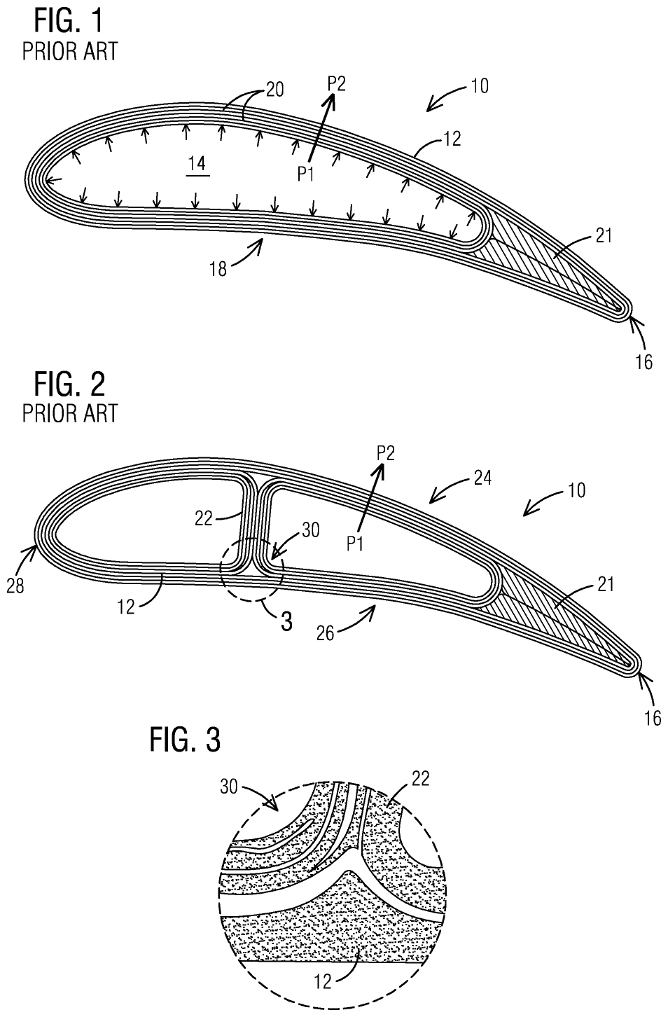

The reinforcement members 110 may comprise any material having a rigidity effective to provide at least a degree of reinforcement to the body of the airfoil 70 in the axial A and/or spanwise R direction against internal pressure forces (see arrows in FIGS. 1-2) and/or compressive forces. In certain embodiments, the reinforcement members 110 comprise a solid material—meaning that any given cross section normal to a spanwise R axis thereof is solid. In certain embodiments, the reinforcement members 110 comprise a ceramic material, a ceramic matrix, or a ceramic matrix composite material. In other embodiments, the reinforcement members may comprise a carbon material.

In certain embodiments, the reinforcement members 110 themselves may comprise a fiber material such as the wall fibers 115. The fiber material may be in any suitable form that provides sufficient rigidity or reinforcement as discussed above, such as in the form of unidirectional fibers, fiber bundles, braided fiber material, ropes or the like. In an embodiment, the reinforcement members 110 comprises at least one of a braided ceramic rope or a hollow braided ceramic rope having a bore, which may be utilized as a pin cooling channel extending therethrough in a lengthwise or spanwise (R) dimension of the fiber material.

It is known that ribs spanning an interior of an airfoil between the pressure side and the suction side comprising a laminated CMC material experience high internal pressure and thus are prone to delamination. The components and processes described herein propose a 3D woven T-joint for an internally pressurized airfoil with increased strength and stiffness and reduced stresses. By including a continuous tensioning fiber attached between the outer wall and the rib at the joint, the rib becomes more robust enabling an airfoil having a thinner walled construction and possibly an airfoil containing fewer ribs.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. An airfoil 70 formed of a three-dimensional ceramic matrix composite (CMC) material, comprising:
an outer wall 12 comprising a pressure side 24 and a suction side 26 of the airfoil 10 defining a cavity 14 through which a flow of cooling air flows;
a rib 22 extending from the pressure side 24 through the cavity 14 to the suction side 26 wherein at an intersection of the rib 22 and the outer wall 12 a T-joint 30 is formed; and
a continuous tensioning fiber 120 attached between the outer wall 12 and the rib 22 and having a portion spanning the T-joint 30 so that the tensioning fiber 120 remains in tension under internal pressure loading to reinforce the T-joint 30,
wherein the tensioning fiber 120, the outer wall 12, and the rib 22 together form the airfoil 70 in the CMC material.

2. The airfoil 70 according to claim 1, wherein the CMC material further comprises a plurality of reinforcement members 110, the reinforcement members 110 extending in a direction perpendicular to the tensioning fiber 120,
wherein the tensioning fiber 120 is woven around the plurality of reinforcement fibers 110.

3. The airfoil 70 according to claim 1, wherein the portion of the tensioning fiber 120 spanning the T-joint 30 forms at least a 45-degree angle with the outer wall 12.

4. The airfoil 70 according to claim 3, wherein the tensioning fiber 120 extends over a first set of selected reinforcement members 110 in a first pass 80 and under the first set of selected reinforcement members 110 in a second pass 82, and wherein the tensioning fiber extends over a second set of selected reinforcement members 110 in a third pass and under the second set of selected reinforcement members 110 in a fourth pass.

5. The airfoil 70 according to claim 4, wherein the first set of selected reinforcement members is in a range of 2-4 and wherein the second set of selected reinforcement members is in a range of 2-4.

6. The airfoil 70 according to claim 5, wherein the tensioning fiber 120 extends over a first pair reinforcement members 110 in the first pass and under the first pair of reinforcement members 110 in the second pass, and wherein the tensioning fiber 120 also extend over a second pair of reinforcement members 110 adjacent to the first pair of reinforcement members and shifted by one reinforcement member in the third pass and under the second pair of reinforcement members 110 in the fourth pass.

7. The airfoil 70 according to claim 1, wherein the tensioning fiber 120 is selected from the group consisting of unidirectional fibers, fiber bundles, and a braided fiber material.

8. The airfoil 70 as claimed in claim 1, wherein the CMC material is an oxide-oxide CMC material.

9. The airfoil as claimed in claim 1, wherein the tensioning fiber is woven about the reinforcement members 110 continuously from the root to the tip of the airfoil 70.

10. A component 70 formed of a 3D ceramic matrix composite (CMC) material, comprising:
a first wall 12;
a second wall 22 that intersects the first wall 12 at an angle such that the intersection forms a T-joint 30;
a continuous tensioning fiber 120 attached between the first wall 12 and the second wall 22 having a portion spanning the T-joint 30 so that the tensioning fiber 120 remains in tension under internal pressure loading to provide strength while reducing stress at the T-joint 30,
wherein the tensioning fiber 120, the first wall, and the second wall 22 together form the component in the CMC material.

11. The component 70 according to claim 10, wherein the CMC material further comprises a plurality of reinforcement members 110, the reinforcement members 110 extending in a direction perpendicular to the tensioning fiber 120,
wherein the tensioning fiber 120 is woven around the plurality of reinforcement fibers 110.

12. The component 70 as claimed in claim 10, wherein the portion of the tensioning fiber 120 spanning the T-joint 30 forms at least a 45 degree angle with the first wall 12.

13. The component 70 according to claim 12, wherein the tensioning fiber 120 extends over a first set of selected reinforcement members 110 in a first pass 80 and under the first set of selected reinforcement members 110 in a second pass 82, and wherein the tensioning fiber extends over a second set of selected reinforcement members 110 in a third pass and under the second set of selected reinforcement members 110 in a fourth pass.

14. The component 70 according to claim 13, wherein the first set of selected reinforcement members is in a range of 2-4 and wherein the second set of selected reinforcement members is in a range of 2-4.

15. The component 70 according to claim 14, wherein the tensioning fiber 120 extends over a first pair reinforcement members 110 in the first pass and under the first pair of reinforcement members 110 in the second pass, and wherein the tensioning fiber 120 also extend over a second pair of reinforcement members 110 adjacent to the first pair of reinforcement members and shifted by one reinforcement member in the third pass and under the second pair of reinforcement members 110 in the fourth pass.

16. The component 70 according to claim 10, wherein the tensioning fiber 120 is selected from the group consisting of unidirectional fibers, fiber bundles, and a braided fiber material.

17. A method of forming a three-dimensional CMC component 70 having a T-joint 30 utilizing a pin weaving technique, comprising:
positioning a plurality of spanwise extending reinforcement members 110 to define an outer wall 12 of the component 70;
positioning a plurality of spanwise extending reinforcement members 110 to define a rib 22, the rib 22 intersecting the outer wall 12 at an angle such that the intersection forms a T-joint 30;
weaving a continuous tensioning fiber about the outer wall 12 reinforcement members 110 for forming the outer wall 12;
weaving the continuous tensioning fiber 120 about the rib reinforcement members 110 for forming the rib 22,
wherein at the T-joint 30, a portion of the tensioning fiber 120 spans the T-joint 30 so that the tensioning fiber 120 remains in tension under internal pressure loading to reinforce the T-joint 30, and
wherein the tensioning fiber 120, the outer wall, the inner wall, and the rib together form the airfoil in the CMC material.

18. The method as claimed in claim 17, wherein the weaving comprises extending the tensioning fiber 120 over a first pair reinforcement members 110 in a first pass and under the first pair of reinforcement members 110 in a second pass and extending the tensioning fiber 120 over a second pair of reinforcement members 110 adjacent to the first pair and shifted by one reinforcement member 110 in a third pass and under the second pair in a fourth pass.

19. The method as claimed in claim 18, wherein the portion of the tensioning fiber 120 spanning the T-joint 30 forms at least a 45-degree angle with the outer wall 12.

20. The method as claimed in claim 17, wherein the tensioning fiber is woven about the reinforcement members 110 continuously from the root to the tip of the airfoil 70.
